(19) United States
(12) Patent Application Publication
(10) Pub. No.: US 2010/0195164 A1
(43) Pub. Date: Aug. 5, 2010

(54) IMAGE FORMING APPARATUS AND IMAGE FORMING METHOD

(75) Inventors: Toru FUJITA, Matsumoto-shi (JP); Takeshi SOWA, Matsumoto-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/697,863

(22) Filed: Feb. 1, 2010

(30) Foreign Application Priority Data
Feb. 2, 2009 (JP) 2009-021143

(51) Int. Cl. G06T 5/00

(52) U.S. Cl. 358/3.26

(57) ABSTRACT

An image forming apparatus that includes a latent image carrier on which a latent image is formed, an exposure head that has a first imaging optical system, first light emitting elements that emit light to be imaged by the first imaging optical system, a second imaging optical system, and second light emitting elements that emit light to be imaged by the second imaging optical system and which form the latent image on the latent image carrier at a position adjacent to the first light emitting elements in a first direction, an image processor that has an input unit to which image data are input, and a data giving unit that gives correction data to correct positional slippage of the latent image formed on the latent image carrier to the input image data.

### BACKGROUND OF THE INVENTION

The entire disclosure of Japanese Patent Application No. 2009-021143, filed Feb. 2, 2009 is expressly incorporated herein by reference.

1. Technical Field

The present invention relates to an image forming apparatus and image forming method. More particularly, the present invention relates to an image forming apparatus and method of making the same with increased image quality due to increased manufacturing assembly accuracy of an imaging optical system.

2. Related Art

Two types of optical printers currently used today which use an exposure head are electro-photographic printers, which use an LED head, and electro-photographic printers, which use a liquid crystal line head. These printers print by converting print data described in a page unit into optical writing data. In the case of color printing, data described in terms of various color coordinates such as RGB are converted into CMYK that can be printed with a printer. Further, an image is expressed as large and small half-tone dots of CMYK by performing a half-tone process in order to express contracting density.

Exposure heads are currently used in such printers and other image forming apparatuses, which have a plurality of light emitting elements such as LEDs arranged in a main scan direction, hereinafter referred to as a first direction. The exposure heads form latent image spots on a photoconductor or latent image carrier by forming an image out of light output from the light emitting elements using lenses. Additionally, an exposure head is also known in which a plurality of light emitting elements arranged in the first direction are divided into several groups and a series of lenses are installed so as to correspond with each light emitting group.

In some instances, a lens of a minus optical magnification is used, such as in an imaging optical system with an image inversion system, and a lens array (MLA) is constructed using a plurality of such lenses. A group of latent image spots formed on the latent image carrier corresponding to one light emitting element group is referred to as a latent image spot group. Further, there is a case where a lens of a plus optical magnification is used, such as in an upright imaging optical system.

JP-A-2008-173889 discloses a technology in which light emitting elements added in advance are arranged so that total number of light emitting elements are more than needed. These additional light emitting elements are referred to as redundant pixels, and they help to suppress the occurrence of lines on the image by overlapping the latent image carrier with the latent image spot even when the interval of latent image spots is changed, such and when a lens magnification error or the like occurs. In this example, when the plurality of overlapping light emitting elements forming the latent image spot are turned on, the same data are given by both the overlapping elements.

As described in Japanese Patent Document JP-A-2008-173889, while it is desirable that positional slippage of a latent image spot is in one pixel, when the slippage is more than one pixel, a latent image spot that intended to be overlapping becomes overlapping. As a result, instances may occur where a corresponding light emitting element creates an overlap between an on spot and an off spot, causing a problem to occur where an image which is different from the desired image was formed.

In order to prevent such a problem from occurring, a configuration may be used where the light of the reduntant light emitting elements are made so as to not overlap on the latent image carrier, such that the redundant pixels are driven when the gap between groups of latent image spots is one pixel or more. On problem with this configuration, however, is that the number of pixels in the main scan direction of the exposure head is increased by the amount of the redundant pixels, meaning that the image data to be transmitted to the exposure head was insufficient.

Furthermore, in some instances the number of redundant pixels is 100 pixels or more in the exposure head corresponding to an A3 width with 1200 dpi. For example, while there are 19800 pixels in an A3 width (about 16.5 inch) with 1200 dpi, 198 lenses are arrayed when a lens is assigned to 100 light emitting elements. At this time, when the magnification error exceeds 1%, the width is slipped by one or more pixels, meaning that redundant pixels are required. That is, it is not possible to reduce the redundant pixels to less than 100 pixels if the magnification errors of half or more of lenses are not suppressed to 1% or less. Therefore, there is a problem that the image quality deteriorates when the manufacturing assembly accuracy of lens is reduced.

### BRIEF SUMMARY OF THE INVENTION

An advantage of some aspects of the invention is to provide an image forming apparatus and image forming method capable of preventing the deterioration of image quality caused by the manufacturing assembly accuracy of the imaging optical system.

A first aspect of the invention is an image forming apparatus which includes a latent image carrier on which a latent image is formed, an exposure head that has a first imaging optical system, first light emitting elements that emit light to be imaged by the first imaging optical system, a second imaging optical system, and second light emitting elements that emit light to be imaged by the second imaging optical system so as to form the latent image on the latent image carrier at a position adjacent to the latent image formed by the first light emitting elements in a first direction, an image processor that has an input unit to which image data are input, and a data giving unit that adds correction data to the image data input to the image processor to correct positional slippage of the latent image formed on the latent image carrier.

A second aspect of the invention is an image forming method which includes forming image data with pixels that are arranged in a first direction and a second direction perpendicular to the first direction, enabling first light emitting elements to emit light to be imaged on a latent image carrier by a first imaging optical system, enabling second light emitting elements to emit light to be imaged by a second imaging optical system and to form a latent image at a position adjacent to the latent image formed by the first light emitting elements of the latent image carrier in the first direction, and adding correction data to correct positional slippage of the latent image formed on the latent image carrier of the input image data in the first direction.

A third aspect of the invention is another image forming method including forming image data with pixels that are arranged in a first direction and a second direction perpendicular to the first direction, enabling first light emitting elements to emit light to be imaged on a latent image carrier by a first imaging optical system, enabling second light emitting elements to emit light to be imaged by a second imaging optical system so as to form a latent image at a position adjacent to the latent image formed by the first light emitting elements on the latent image carrier in the first direction, adding correction data to correct a positional slippage of the latent image formed on the latent image carrier of the input image data in the first direction, and enabling third light emitting elements to emit light according to the correction data so that the third light emitting elements correct the positional slippage of the latent image.

### BRIEF DESCRIPTION OF THE DRAWINGS

The invention will be described with reference to the accompanying drawings, wherein like numbers reference like elements.

FIG. 1 is a block diagram showing an embodiment of the invention;

FIG. 2 is a flowchart illustrating an embodiment of the invention;

FIG. 3 is a flowchart illustrating an embodiment of the invention;

FIG. 4 is a block diagram showing an embodiment of the invention;

FIG. 5 is a flowchart illustrating an embodiment of the invention;

FIGS. 6A and 6B are explanation views showing an embodiment of the invention;

FIGS. 7A and 7B are explanation views showing an embodiment of the invention;

FIGS. 8A and 8B are explanation views showing an embodiment of the invention;

FIG. 9 is an explanation view showing an embodiment of the invention;

FIG. 10 is an explanation view showing an embodiment of the invention.

FIG. 11 is an explanation view showing an embodiment of the invention;

FIG. 12 is a block diagram showing an embodiment of the invention;

FIG. 13 is a mimetic sectional diagram showing an entire construction of an embodiment of an image forming apparatus using an electro-photographic process of the invention;

FIG. 14 is an explanation view showing a background technology of the invention; and

FIGS. 15A and 15B are explanation views showing a background technology of the invention.

### DESCRIPTION OF EXEMPLARY EMBODIMENTS

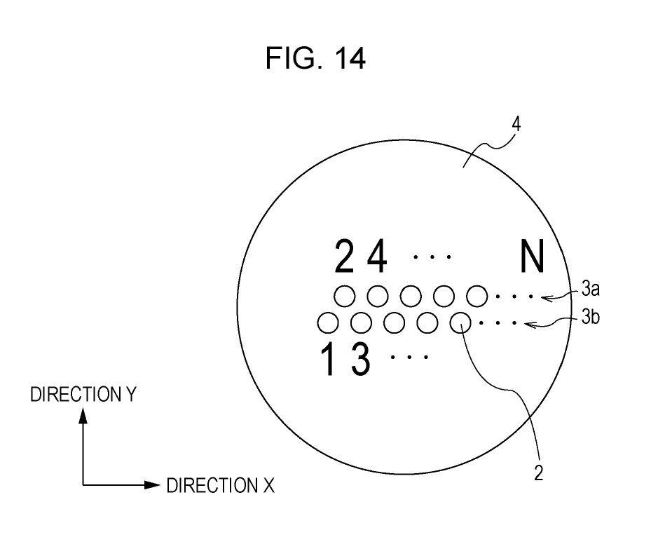

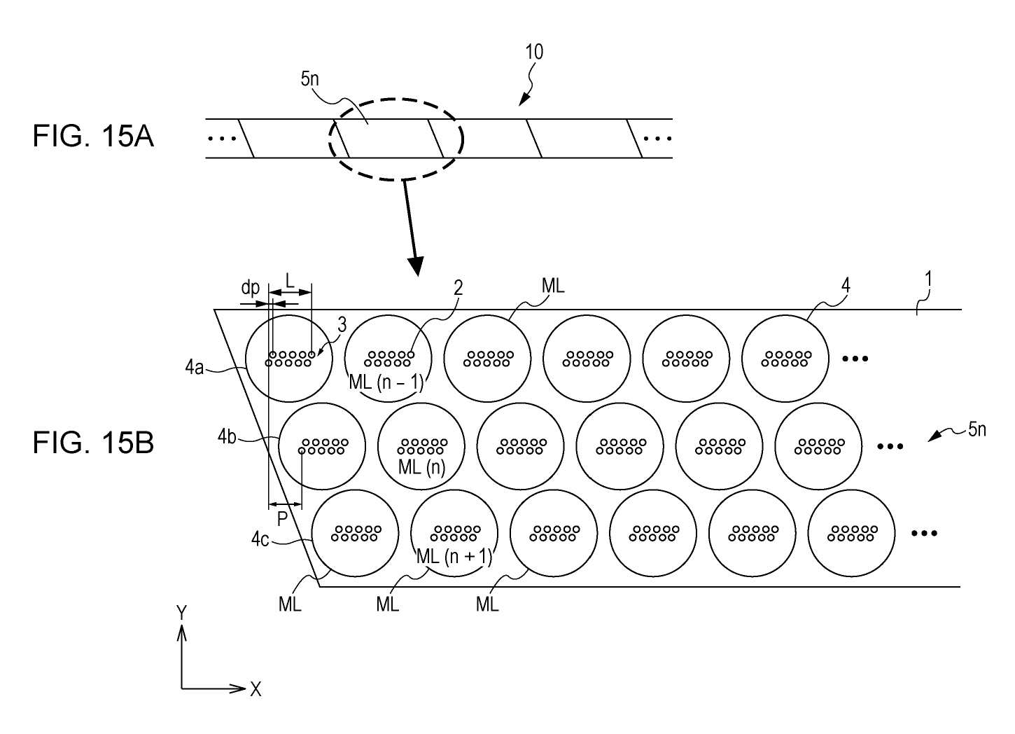

Hereinafter, the invention will be described with reference to various embodiments which are capable of performing aspects of the invention. FIGS. 14 to 15B are explanation views showing the background technology of the invention. FIG. 14 shows an arrangement relationship between a lens of a minus optical magnification ML and light emitting elements (dots). Referring to FIG. 14, 2 or more light emitting elements 2 are arranged in ML4 in the axial direction of a photoconductor, which is also referred to herein as the X direction or a first direction, and in a rotational direction of the photoconductor, which is also referred to herein as the Y direction or second direction. A latent image is formed on the photoconductor using these light emitting elements.

The light emitting element 2 has numbers “1 to N” attached for convenience's sake. Light emitting element row 3a of a first column shown in the Y direction has light emitting elements of “2, 4, . . . N” arranged from the left to the right shown in the X direction. Light emitting element row 3b arranged in a second column of the Y direction has light emitting elements of 1, 3, . . . . Here, 2 or more lenses 4 construct a lens array MLA which is arranged in the X direction. Further, it is possible to construct a lens array by arranging 2 or more lenses in the X and Y directions. Here, the light emitting elements “2, N” are light emitting elements arranged at the ends of the lens ML in the X direction.

FIGS. 15A and 15B are explanation views of an exposure head using a lens array having a minus optical magnification. When the number of light emitting elements (the number of dots) to form a latent image of one line in the axial direction of the photoconductor is increased, a lens array that is long in the axial direction of the photoconductor is needed. In such a case, it is possible to form a long exposure head by connecting a plurality of lens arrays, where each array has a fixed length.

FIG. 15a shows a schematic construction of a long exposure head 10, and FIG. 15b mimetically shows a portion of FIG. 15a. FIG. 15a shows a long exposure head 10, and 5n is a lens array of a portion of the long exposure head. FIG. 15b is an enlarged view showing the lens array 5n.

Referring to FIG. 15b, the exposure head has 2 or more light emitting elements 2 arranged on a substrate 1. 3 denotes a light emitting element group formed of 2 or more light emitting elements arranged on one lens 4a. The light emitting element group 3 has 2 or more light emitting elements arranged in the axial direction X of the photoconductor and the rotational direction Y of the photoconductor. Element 4 is a lens, and 2 or more lenses arranged in the axial X direction and the rotational Y of the photoconductor construct a lens array.

In the example of FIG. 15b, lenses 4a, 4b and 4c are arranged in the Y direction. This lens arrangement in the Y direction can be expressed as ML(n+1), ML(n−1) with reference to ML(n) when viewed from the rotational position of the photoconductor. In the lens 4a, L denotes a width of 1 row of light emitting elements arranged in the X direction in one lens, dp denotes an interval of light emitting elements, and P denotes a distance between first dots in the X direction in the lenses 4a and 4b adjacent to each other in the Y direction.

As shown in FIG. 15a, in the case that a plurality of MLAs are connected in the axial direction of the photoconductor, when a manufacturing assembly accuracy of the lens array is reduced, there occurs an imbalance between pitches of connection portions among the MLAs, and a resist slippage, or positional slippage, may occur. Accordingly, there is a problem that image quality of the image formed deteriorates.

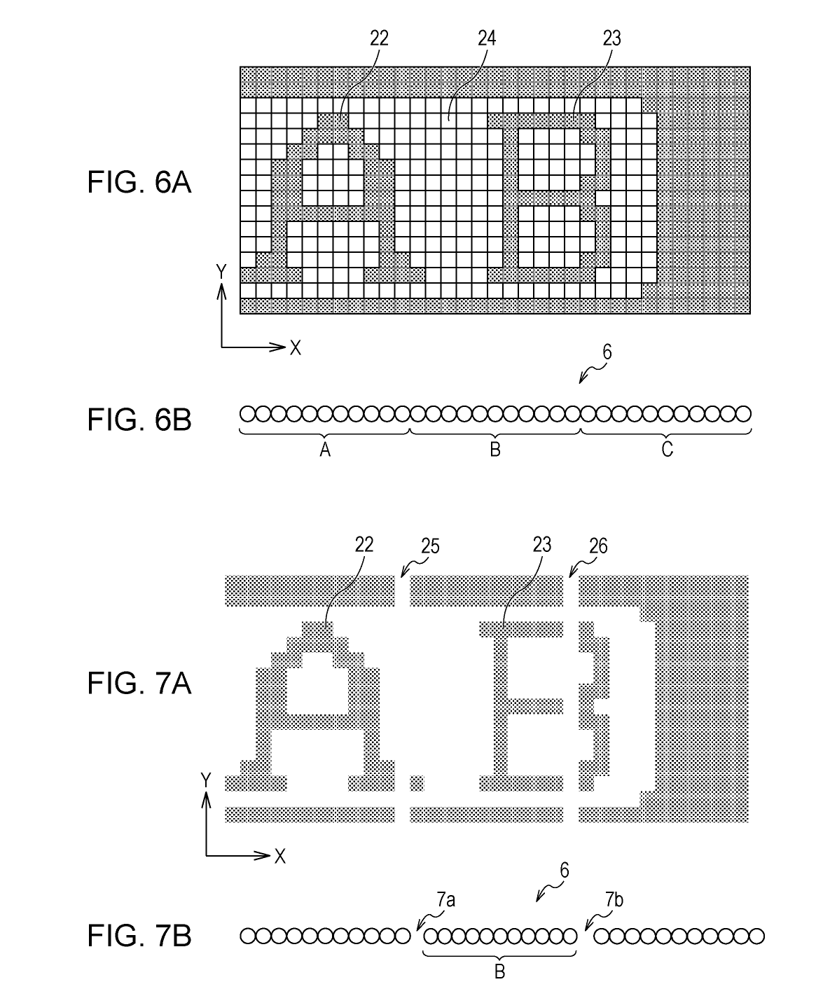

FIGS. 6A to 11 are explanation views conceptually showing an operation of the invention. “A” 22 and “B” 23 in FIG. 6A are images to be output, and each lattice 24 corresponds to one pixel. In FIG. 6A, the longitudinal direction Y is denoted as the sub-scan direction, and the latitudinal direction X is denoted as a main scan direction. This image is constructed of 33 pixels in the main scan direction and 16 pixels in the sub-scan direction.

FIG. 6B shows a position of a latent image spot 6 that is ideally arranged without a lens magnification error and the like. Referring to this drawing, each light emitting element group is constructed of 11 light emitting elements, such that the 33 pixels of the image are divided into 3 light emitting element groups. The image of FIG. 6A is output by latent image spot groups A, B and C corresponding to the light emitting element groups, respectively.

As described above, an arrangement of the latent image spot 6 may be slipped from an ideal position by the magnification error or the like. FIG. 7B shows such an example, in which the arrangement is slipped in the direction where the absolute value of the magnification of the lens corresponding to the latent image spot group B is small so that pitch between the latent image spots is reduced. In such a case, since gaps 7a and 7b can be formed in the latent image spot in the adjacent portion of the latent image spot groups A and B, and B and C, a white line enters into the image output. FIG. 7A is a view mimetically showing an output in a case that an image was formed in the state of FIG. 7B. As shown in FIG. 7A, gaps in the latent image spot 6 result in white lines 25 and 26 being formed into the image and the image is divided.

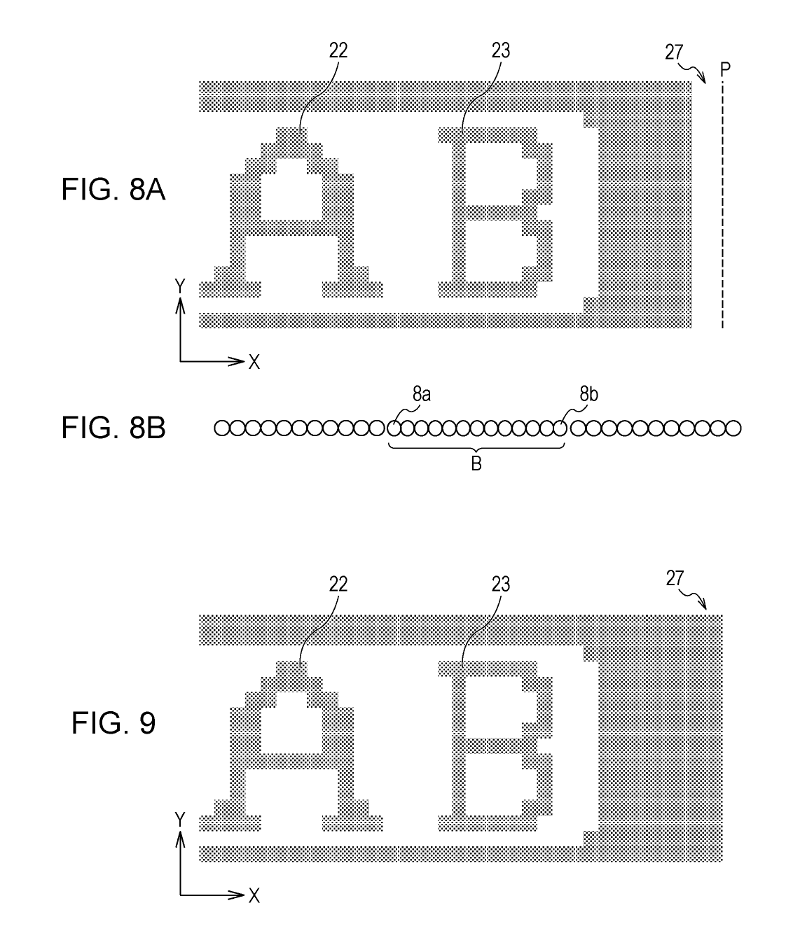

Referring to FIG. 8B, in order to suppress of the occurrence of white lines 25 and 26 like those shown in FIG. 7A, the number of the light emitting elements in the light emitting element group B is increased by 2, such that the light emitting element group B has 13 light emitting elements. 8a and 8b are latent image spots formed by added light emitting elements. As such, by adding the light emitting elements, the image division is suppressed as shown in FIG. 8A. However, the right end of the image 27 has slippage occurring toward the left away from the location P where the right end of the image should be disposed. It is because the amount of data does not increase even though the light emitting elements has increased from 33 to 35.

Next, an aspect of the invention will be described with reference to an embodiment illustrated in FIGS. 9 to 11. FIG. 9 is a explanation view showing an operation in accordance with a first pixel insertion method. In an example of FIG. 9, information that 2 pixels are inserted in the main scan direction (X direction) is given, and 2 pixel data of the main scan direction end portion 27 are repeatedly added. In the main scan direction end portion 27, 2 more pixel data referred to as a dot on of a pixel are added at the end portion and the image is embedded up to the position P. Accordingly, positional slippage shown in FIG. 8A does not occur. Further, no gaps or spaces are formed in the image.

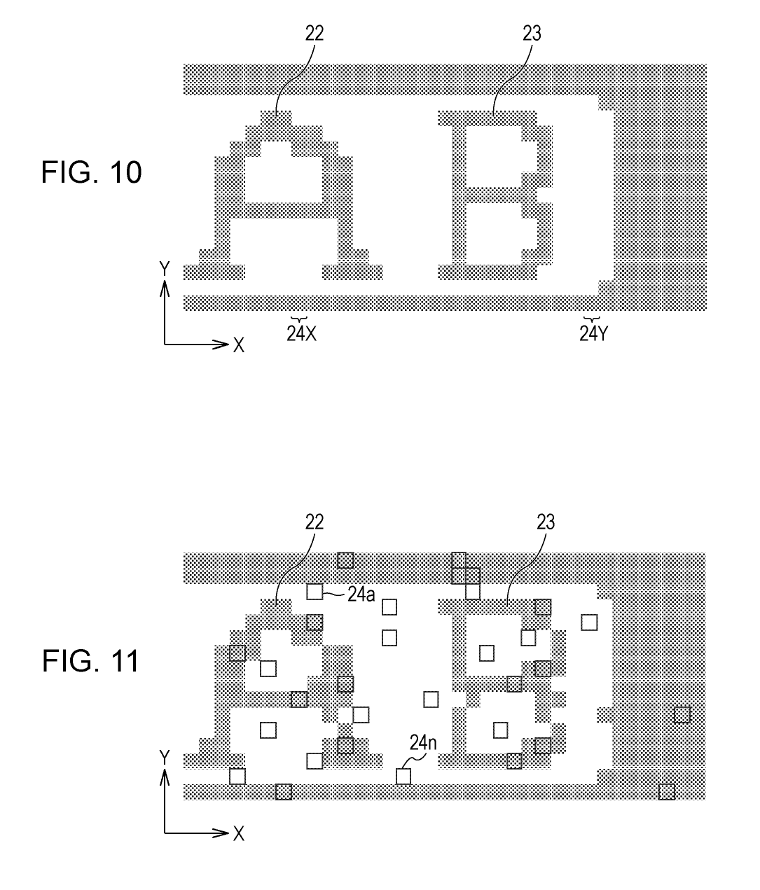

FIG. 10 is a explanation view showing an operation in accordance with a second pixel insertion method. In an example of FIG. 10, positions to which 2 pixel data are added are equally arranged in the main scan direction (X direction). That is, while the original number of pixels is 33, that is divided into 2 nearly equal areas of 16 pixels and 17 pixels, and image data are added into the central portions of each area. The added data may be the pixel data of a left neighboring pixel in the main scan direction of the position to be added. 24X and 24Y are insert portions of the added data. Compared to a case where the data are added to the end portion of the main scan direction shown in FIG. 9, there is the benefit in that the collapse of balance in the entire position is small.

In the method shown in FIG. 10, the pixel inserting position can be more generally expressed as follows.

POSi (i=1,N)=(W/N)·(i−1)+(W/2N)

Here, POSi is a position of ith inserting portion, W is width of image in the main scan direction (number of pixel), and N is the number of pixels to be inserted. Further, when the W/N and W/2N are not integers like the example of FIG. 10, approximate integers may be used by rounding off to the nearest integer or the like.

FIG. 11 is a explanation view showing an operation in accordance with a third pixel insertion method. In an example of FIG. 11, positions to which 2 pixel data are added are randomly determined by the position of the main scan direction (Y direction). While the positions to which the pixel data were added become a pattern which differs from the original, the occurrence of differences between the patterns occurring in the same area is prevented by randomly arranging such positions. 24a to 24n in FIG. 11 indicate the inserted pixels by enclosing them with frames. As shown in FIG. 11, the patterns are prevented from continuously being collapsed in the sub-scan direction.

Further, in the method of FIG. 11, the positions where the data are added to each raster in the sub-scan direction are changed. Such an effect can also be realized by moving the position added to each raster aside using a rule determined in advance other than the method of FIG. 11 where added positions are randomly determined. Here, “raster” indicates image data of one row in the main scan direction (X direction), and page date is constructed by stacking the raster in the sub-scan direction (Y direction).

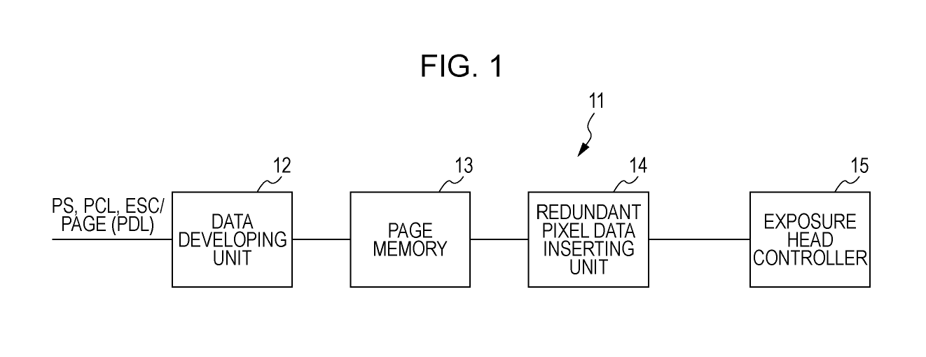

FIG. 1 is a conceptual view showing a construction of a controller 11 in accordance with an image forming apparatus of the invention. The controller 11 includes a page data developing unit 12, a page memory 13, a redundant pixel data inserting unit 14, and an exposure head controller 15. In a normal print process of a printer, page data are described in a page description language PDL such as PS, PCL and ESC/Page. The page data are developed into a bitmap image in the page data developing unit 12 and stored in the page memory 13.

According to an aspect of the embodiment of the invention, a redundant pixel data inserting unit 14 which processes the data between the page memory 13 and the exposure head controller 15. The redundant pixel data inserting unit 14 adds some data to print data transmitted from the page data developer 12 and transmits them to the exposure head controller 15. The redundant pixel data inserting unit 14 is given information of how much data should be added and then adds the proper amount of data. An image is formed by transmitting the information to the exposure head controller 15 one raster at a time, driving the exposure head synchronously with the print operation of a print engine and writing the image data on the photoconductor.

Here, a simple description of the exposure head controller 15 will be given. In order to drive a plurality of light emitting elements of the exposure head, there exist various driving methods such as dynamic driving and the like, and control circuits are needed for them. Further, when an imaging optical system is erected or reversed (minus optical magnification) according to kinds of exposure head, the ability to exchange data in parallel is needed.

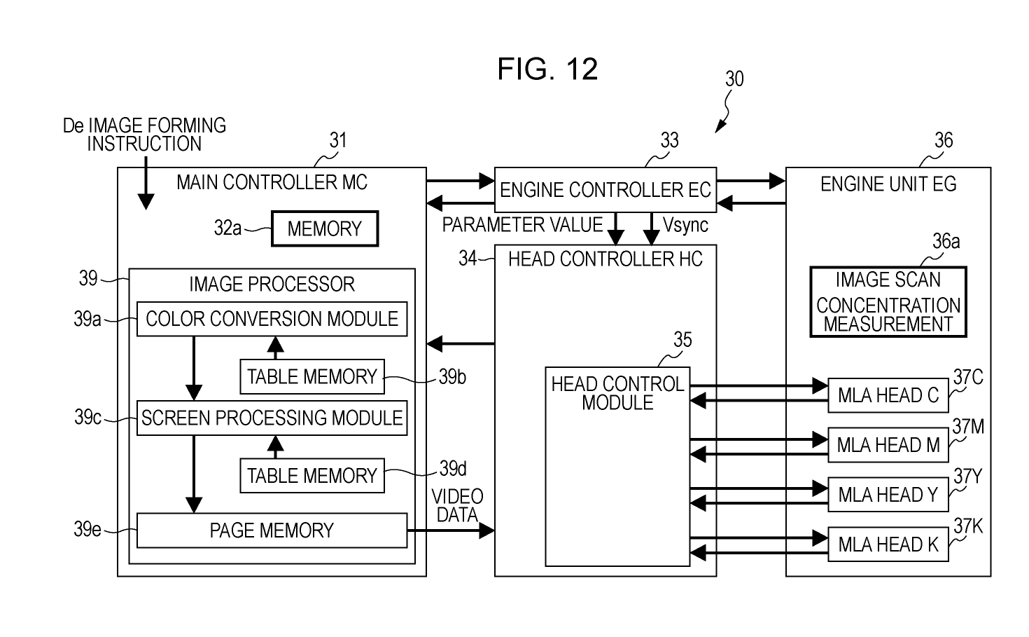

As such, the head controller realizes a function of exchanging data in parallel. The head controller is denoted as reference number 34 in FIG. 12, and constructed as an independent controller since it normally should be moved in a high speed compared with other portions. The head controller 34 is transmitted with data indicating the on and off state of the latent image spot orderly in the main scan direction. The head controller properly exchanges data arranged orderly in parallel in the main scan direction and generates driving signals of the exposure head, according to constructions of the exposure head and the driving circuit.

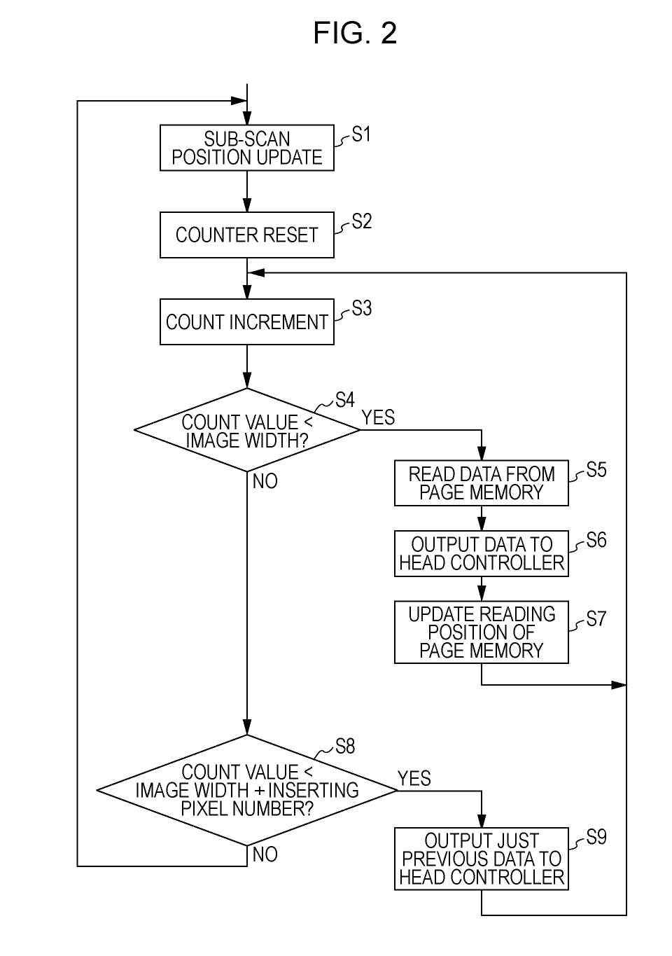

FIG. 2 is a flowchart illustrating an operation of a redundant pixel data inserting unit in accordance with a first pixel inserting method of the invention described in FIG. 9.

At S1, the front end of a page and the read-out position from a page memory is set in an image upper end raster when the position of the sub-scan direction is updated. At S2, the counter which is used to count the position of the pixel in the main scan direction is reset. At S3, the counter is added to by 1 (count increment).

Then, at S4, a determination is made as to whether the count value is less than the number of pixels of the image width or not. When the count value is less than the number of pixels of the image width, the pixel data are read in from the page memory at S5. Then, at S6, the data are output to the head controller, and at S7 the read out position of the page memory is added by 1 to be updated, and next pixel process is executed by returning to S3.

When the count value is not less than the image width in the determination made at S4, a determination is made at S8 as to whether the count value is less than the sum of the width of the image and the number of inserted pixels.

If it is determined that the count value is not less than the sum of the number of the inserted pixels, since the process is completed up to the end in the main scan direction, the next raster process is performed after returning to position of the update in the main scan direction of S1. The print of image is performed by repeating those processes up to the end of the page.

On the other hand, if it is determined that the count value is less than the sum of the number of the inserted pixels at S8, the data that was previously output are again output to the head controller at S9 instead of newly reading out data from the page memory. Then, the next pixel process is executed after returning to S3.

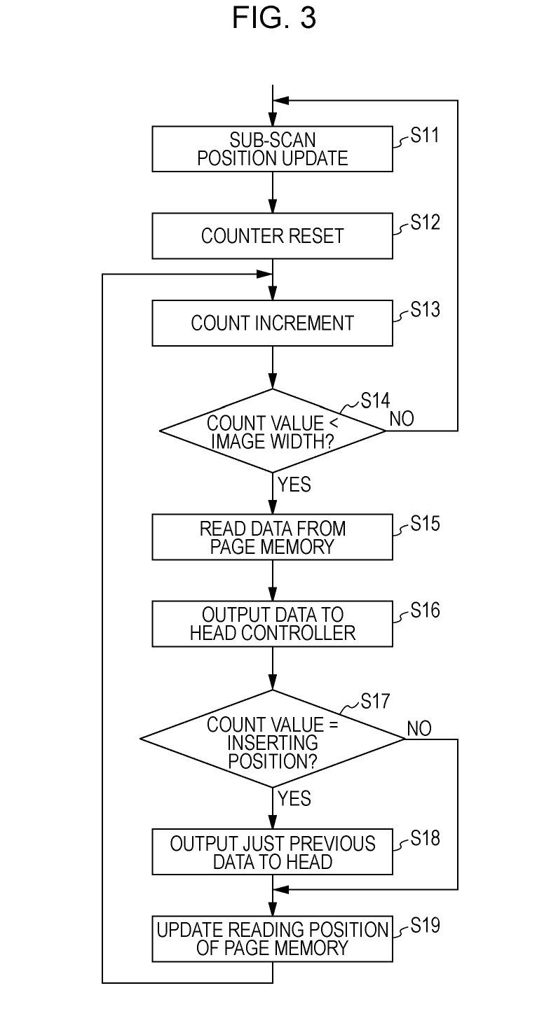

FIG. 3 is a flowchart illustrating an operation of a redundant pixel data inserting unit used in the second and third pixel inserting methods of the invention described in FIGS. 10 and 11. Before beginning to process the page, a position to which a pixel is inserted is obtained in the method described above and given to the redundant pixel data inserting unit. First, a the front end of a page, a read-out position from page memory is set in an image upper end raster when the position of the sub-scan direction is updated at S11. Next, a counter to count the position of the pixel in the main scan direction is reset at S12. Subsequently, the counter is added to by 1 (count increment) at S13.

Then a determination is made as to whether the count value is less than the number of pixels of the image width or not at S14. If not, a next raster process is performed after returning to an update of the position in the sub-scan direction of S11.

On the other hand, when the count value is determined to be less than the number of the pixel of the image width at S14, pixel data are read in from the page memory at S15. Then data are output to the head controller at S16.

Then, at S17, a determination is made as to whether the count value is an inserting position (a position to which pixel is to be inserted) or not. When the count value is not the inserting position, the read out position of the page memory is updated at S19 and the process returns to S13 for a subsequent pixel.

If the count value is determined to be the inserting position at S17, the previously output data are once again transmitted to the head controller at S18.

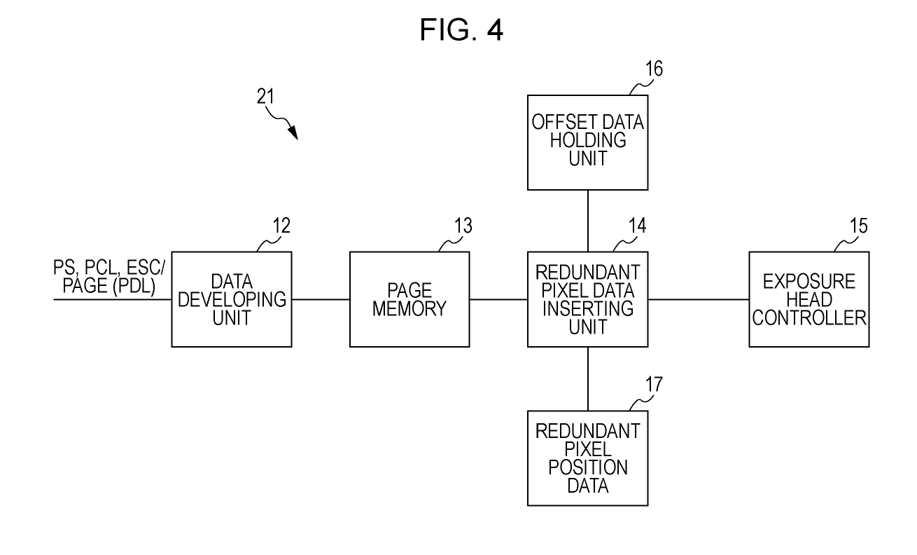

FIG. 4 is a block diagram showing a construction of a modified example of the invention. In a controller 21, the same elements as FIG. 1 have same symbol, and their detailed descriptions are omitted. A redundant pixel data inserting unit 14 is connected to an offset data holding unit 16 and a redundant pixel position data holding unit 17. Referring to FIG. 4, the redundant pixel data inserting unit 14 refers to the redundant pixel position data holding unit 17 and a pixel is inserted into a portion where the redundant pixel is used. While some redundant pixels are used in the middle of the width of the exposure head, their total positions are held as information of their orders in the main scan direction. Further, in an example of FIG. 4, an offset data holding unit 16 offsets total image data.

As previously described, the positional relation of the exposure head and the print paper may be slipped from its design position by the assembly accuracy of the head and assembly accuracy of print paper transportation parts. Further, printing is sometimes performed under the state that a position of image on the paper is intentionally slipped with respect to the paper. By using the system and methods described herein, such need can be met by holding the obtained slippage as offset data and transmitting image data to the head controller with reference to the data from the redundant pixel data inserting unit.

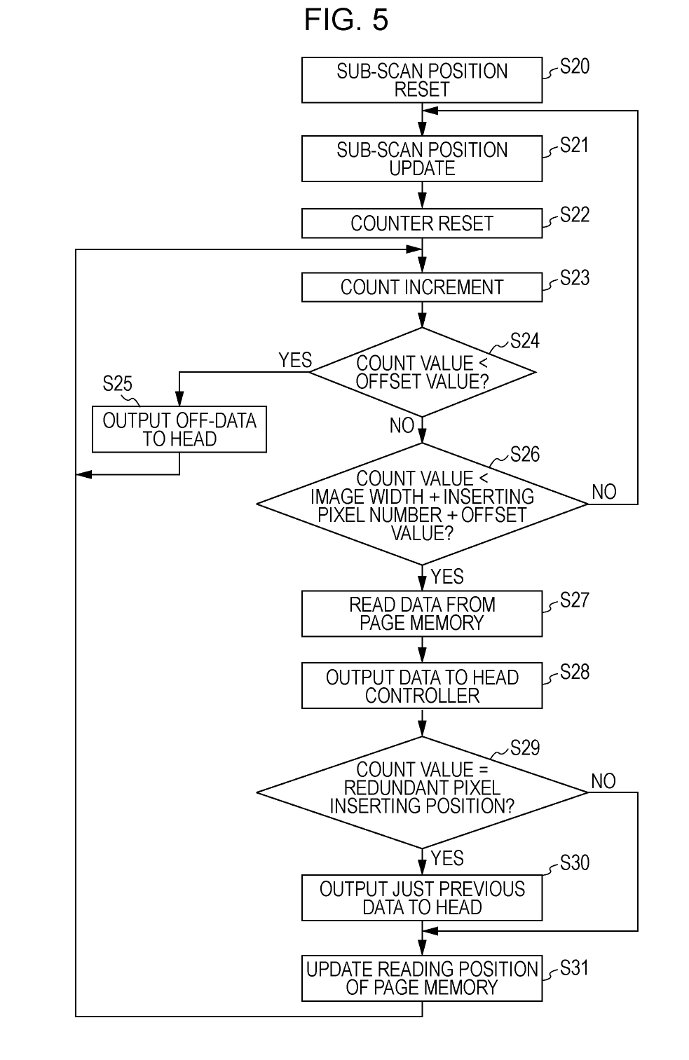

FIG. 5 is a flowchart illustrating an operation of redundant pixel data inserting unit of an example of FIG. 4.

At the front end of a page, a read-out position from a page memory is set in an image upper end raster when a position of the sub-scan direction is reset at S20. Then, a read-out position from the page memory is set in the next raster when the position of the sub-scan direction is updated at S21. Next, a counter to count the pixel position in the main scan direction is reset, at S22, and at S23 the counter is added to by 1 (count increment).

At S24 a determination is made as to whether the count value is less than the offset value or not. When the count value is less than the offset value, off data (light emitting element non-on) are transmitted to the head controller at S25, and the process is returned to the count increment of S23.

On the other hand, when the determination result of S24 is No, another determination is made at S26 as to whether the count value is less than the sum of the offset value+the number of pixels of an image width+the number of inserted pixel. As a result of the determination of S26, when the count value is greater than the sum value, since the process is completed up to the end of the raster, the process is returned to a positional update in the sub-scan direction in S21 and the process of the next raster is performed.

Conversely, When the count value is determined at S26 to be less than the sum, data are read in from the page memory at S27 and the read in data are transmitted to the head controller at S28.

At S29 another determination is made as to whether the count value is a redundant pixel inserting position (a position where the redundant pixel is used) or not. When the count value is not the redundant pixel inserting position, the process moves to S31, where the read-out position of the page memory is updated as it is, and moves to a next pixel process.

Alternatively, when the count value is the redundant pixel inserting position, the previous output data is transmitted again to the head controller.

At S31, the read-out position of the page memory is updated, and moves to a next pixel process. These processes are repeated up to the end of the page so the print of an image is performed.

FIG. 12 is a block diagram showing an embodiment of the invention. Referring to FIG. 12, 30 denotes an image forming apparatus (printer), that has a main controller MC 31, an engine controller EC 33, a head controller HC 34 and an engine unit EG 36. Further, an image forming instruction is output to the main controller MC 31 from a printer server such as an external PC or the like that is omitted from the diagram.

The main controller MC 31 has a memory 32a to store individual information such as redundant dots of a lens array, a color conversion module 39a and a table memory 39b having a table data for the color conversion module mounted therein. Further, a screen process module 39c, a table memory 39d having table data for the screen process module and a page memory 39e to store the print image data are installed therein. Further, the memory 32a stores the data from the engine controller EC 33 and the head controller HC 34.

The corresponding relation of FIG. 12 and FIG. 1 is described. The data developing unit 12 of FIG. 1 is installed in the image processor 39. The page memory 13 corresponds to the page memory 39e. The redundant pixel data inserting unit 14 is installed in the image processor 39. The redundant pixel data inserting unit 14 functions as a data giving unit to give dot data to correct the positional slippage of an image forming spot formed on the latent image carrier to the image data. The exposure head controller 15 corresponds to the head controller 34. Further, the offset data holding unit 16 in FIG. 4 and the redundant pixel position data holding unit 17 are also installed in the image processor 39 in FIG. 12.

Referring to FIG. 12, line distortion of the light emitting elements may be measured with a measuring means such as an optical sensor and measured results may be stored in the memory 32a of the main controller MC 31, for example. The processes of on and off data forming of all light emitting elements including added light emitting elements is executed by the CPU of the main controller MC 31. The head controller HC 34 has a head control module 35 installed therein. The head control module 35 transmits print data correspondingly to exposure head (MLA head) 37C, 37M, 37Y and 37k of 4 colors C, M, Y and K. The engine controller EC 33 controls the head control module 35 and the engine unit EG 36. The engine unit EG 36 has an image scan concentration measuring unit 36a to scan the image and measure the concentration installed therein.

Referring to FIG. 12, a print command is transmitted from the main controller MC 31 to the engine controller EC 33 and the main controller MC 31 forms a print pattern and transmits data (Video DATA) stored in the page memory 39e to the head controller HC 34. The engine controller EC 33 controls print made by the engine unit EG 36 and the head controller HC 34 transmits print data to the exposure heads 37C to 37K. After printing, the image data scanned and the result of image concentration measured in the engine unit EG 36 are informed to the main controller MC 31. It may be desirable to have a construction that the scan and concentration measurement of the image are performed in a separate apparatus of the image forming unit 30, for example, the head controller HC 34.

The main controller MC 31 determines whether the intended print result is performed by the received scan data and concentration measurement data and performs a feedback control to the image processor 30. The feedback to the image processor 30 is to change values of the color conversion table or parameters for color conversion and values of screen table or parameters for screen process.

According to an aspect of the invention, a print system using an exposure head having a lens array of a minus optical magnification includes a unit to add dot data to correct positional slippage of an image forming spot formed on a latent image carrier to image data transmitted to the exposure head in order to prevent deterioration of image quality due to manufacturing assembly accuracy of the imaging optical system from occurring.

The image forming apparatus in accordance with an aspect of an embodiment of the invention, for example, makes use of an exposure head having a first light emitting element to emit light formed in the first imaging optical system 4a (corresponding to a light emitting element 2 of a light emitting element group 3 installed correspondingly to a first imaging optical system 4a) and a second light emitting element to emit light that forms an image on the second imaging optical system 4b and the second imaging optical system and to form a latent image on the latent image carrier at a position neighboring the first light emitting element (the light emitting element 2 of the light emitting element group 3 installed correspondingly to the second imaging optical system 4b) described in FIG. 15b. The controller of the image forming apparatus has installed therein an input unit to which image data are input and an image processor including a data giving unit to give dot data (redundant pixel data described in FIG. 1) to correct positional slippage of an image forming spot formed on the latent image carrier to the input image data. Here, as described in FIG. 8B, the light emitting elements of both ends in a first direction of the light emitting elements group B added to form the latent image spots 8a and 8b functions as a third light emitting element to correct positional slippage of the latent image spot.

The image forming apparatus may be embodied in a variety of configurations, including 1) Data addition provided to the added light emitting element is performed at the end of the image in the main scan direction (first direction). (2) Or, the addition of the data may be equally distributed in the main scan direction of the image. (3) Further, the addition of data may be performed at random positions in the main scan direction of the image. (4) Further, the added positions of the data become different according to positions in the sub-scan direction of the image (second direction).

(5) Further, the addition of data is performed at a position to which redundant pixels are inserted.

(6) Further, added image data are offset in the main scan direction. (7) At this time, the offset is performed by inserting blank data into the end of the image in the main scan direction and copying the data that are not on the end in the main scan direction after slipping them in the main scan direction.

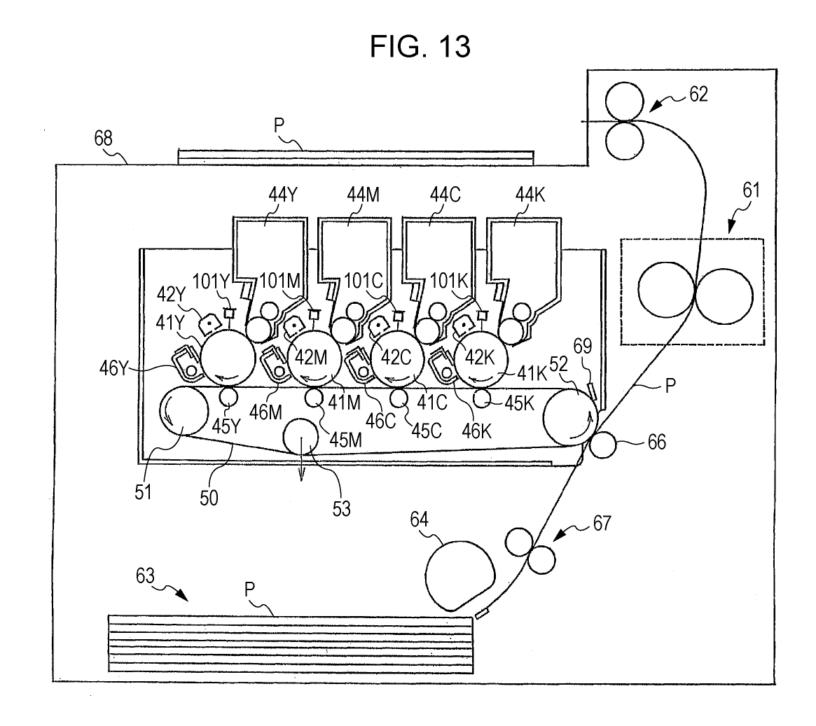

According to an aspect of an embodiment of the invention, an exposure head used in a tandem color printer (image forming apparatus) is provided in which 4 photoconductors are exposed using 4 exposure heads, 4 color images are formed at the same time, and the images are transferred to one endless middle transfer belt (middle transfer belt). FIG. 13 is a longitudinal sectional side view showing an example of the tandem image forming apparatus that uses an organic EL element as a light emitting element. The image forming apparatus has four exposure heads 101K, 101C, 101M and 101Y of the same construction arranged correspondingly to exposure positions of 4 photoconductor (latent image carrier) 41K, 41C, 41M and 41Y of the same construction.

As shown in FIG. 13, the image forming apparatus has installed therein a driving roller 51, a driven roller 52 and a tension roller 53, and includes a middle transfer belt 50 circularly driven by the tension roller 53 in the arrow direction (counter clock direction). The photoconductors 41K, 41C, 41M and 41Y are arranged with respect to this middle transfer belt 50 with predetermined intervals. K, C, M and Y added following the symbol mean black, cyan, magenta and yellow, respectively. The photoconductors 41K to 41Y are rotationally driven synchronously with the driving of the middle transfer belt 50 in the arrow direction (clockwise direction). An electric charging unit 42 (K, C, M and Y) and exposure head 101 (K, C, M and Y) are installed near each photoconductor (K, C, M and Y).

Further, the image forming apparatus has developing apparatus 44 (K, C, M and Y) that forms a visible image by giving the toner being the developing agent to an electrostatic latent image formed by the exposure head 101 (K, C, M and Y), a primary transfer roller 45 (K, C, M and Y), and a cleaning apparatus 46 (K, C, M and Y). It is established that light emitting energy peak wavelength of each line head 101 (K, C, M and Y) and sensitivity peak wavelength of the photoconductor 41 (K, C, M and Y) are roughly identical each other.

Each toner image of black, cyan, magenta and yellow formed by single color toner image forming station of 4 colors is sequentially transferred on the middle transfer belt 50 by a primary transfer bias applied to the primary transfer roller 45 (K, C, M and Y). A toner image that has been colored by being sequentially overlapped on the middle transfer belt 50 is secondarily transferred to a recording medium P such as paper using the secondary transfer roller 66, and passes through a fixing roller pair 61 being a fixing unit so that it is fixed on a recording medium P. Further, it is discharged on a sheet discharging tray 68 formed on the apparatus by a sheet discharging roller pair 62.

A sheet feeding cassette 63 stacks and holds a plurality of recording media P, and a pickup roller 64 transports the recording medium P from a sheet feeding cassette 63 one by one. A gate roller pair 67 define the sheet feeding timing of the recording medium P to a secondary transfer unit of the secondary transfer roller 66, which acts as a secondary transfer unit, and is driven against a middle transfer belt 50. A cleaning blade 69 removes the toner remaining on the surface of the middle transfer belt 50 after the secondary transfer.

Hereinbefore, while the image forming apparatus and image forming method in accordance with the invention capable of suppressing deterioration of image quality is described on the basis of its principle and embodiments, the invention is not restricted to these embodiments and may be modified in a variety of ways without departing from the scope of the following claims.

What is claimed is:

1. An image forming apparatus, comprising:
a latent image carrier on which a latent image is formed;
an exposure head that has a first imaging optical system, first light emitting elements that emit light to be imaged by the first imaging optical system, a second imaging optical system, and second light emitting elements that emit light to be imaged by the second imaging optical system so as to form the latent image on the latent image carrier at a position adjacent to the latent image formed by the first light emitting elements in a first direction;
an image processor that has an input unit to which image data are input, and a data giving unit that adds correction data to the image data input to the image processor to correct positional slippage of the latent image formed on the latent image carrier.

2. The image forming apparatus according to claim 1, wherein the image data are formed as pixels arranged in the first direction and a second direction which is perpendicular to the first direction, further comprising third light emitting elements which are used to correct the positional slippage of the latent image.

3. The image forming apparatus according to claim 2, wherein the correction data are arranged in the first direction of the image data.

4. The image forming apparatus according to claim 2, wherein the correction data are given in the second direction of the image data.

5. The image forming apparatus according to claim 2, wherein the given correction data are input to the third light emitting elements.

6. The image forming apparatus according to claim 1, wherein the first imaging optical system and the second imaging optical system have a minus optical magnification.

7. An image forming method, comprising:
forming image data with pixels that are arranged in a first direction and a second direction perpendicular to the first direction;
enabling first light emitting elements to emit light to be imaged on a latent image carrier by a first imaging optical system;
enabling second light emitting elements to emit light to be imaged by a second imaging optical system so as to form a latent image at a position adjacent to the latent image formed by the first light emitting elements of the latent image carrier in the first direction; and
adding correction data to correct a positional slippage of the latent image formed on the latent image carrier of the input image data in the first direction.

8. An image forming method, comprising:
forming image data with pixels that are arranged in a first direction and a second direction perpendicular to the first direction;
enabling first light emitting elements to emit light to be imaged on a latent image carrier by a first imaging optical system;
enabling second light emitting elements to emit light to be imaged by a second imaging optical system so as to form a latent image at a position adjacent to the latent image formed by the first light emitting elements on the latent image carrier in the first direction;
adding correction data to correct a positional slippage of the latent image formed on the latent image carrier of the input image data in the first direction; and
enabling third light emitting elements to emit light according to the correction data so that the third light emitting elements correct the positional slippage of the latent image.
